(19) United States
(12) Patent Application Publication
(10) Pub. No.: US 2017/0297489 A1
(43) Pub. Date: Oct. 19, 2017

(54) Method and System for Representing Vehicle Surroundings of a Motor Vehicle on a Display Device Located in the Motor Vehicle

(71) Applicant: Conti Temic microelectronic GmbH, Nuernberg (DE)

(72) Inventor: Guenter Anton FENDT, Schrobenhausen (DE)

(73) Assignee: Conti Temic microelectronic GmbH, Nuernberg (DE)

(21) Appl. No.: 15/513,004

(22) PCT Filed: Nov. 11, 2015
(86) PCT No.: PCT/DE2015/200497

§ 371 Date: Mar. 21, 2017

(30) Foreign Application Priority Data
Dec. 3, 2014 (DE) 10 2014 224 795.0

(51) Int. Cl. B60R 1/00; G06K 9/00; G06T 7/11; H04N 5/247

(52) U.S. Cl. CPC B60R 1/00; H04N 5/247; G06K 9/00791; G06T 7/11; B60R 2300/105; B60R 2300/303; B60R 2300/802; B60R 2300/70

(57) ABSTRACT

A method is for representing vehicle surroundings on a display device arranged in a motor vehicle, which has a first camera for detecting a first surrounding region of the motor vehicle and a second camera for detecting a second surrounding region of the motor vehicle. The first and second surrounding regions have an overlapping area. The method involves: receiving an activation signal to represent the first surrounding region on the display device; upon receiving the activation signal, detecting whether there is a malfunction of the first camera; representing the first surrounding region on the display device when there is no malfunction of the first camera; and representing at least part of the second surrounding region on the display device as an alternative when there is a malfunction of the first camera.

The invention relates to a method and a system for representing vehicle surroundings of a motor vehicle on a display device located in the motor vehicle, wherein in the event of a malfunction of a first camera mounted on the motor vehicle, instead of the data detected by the first camera, data detected by a second camera mounted on the motor vehicle, the field of view of which overlaps with the field of view of the first camera, are alternatively displayed on the display device.

For monitoring a rear vehicle environment of a motor vehicle by a driver of the motor vehicle, in addition to an internal mirror of the motor vehicle, left and right exterior mirrors are also usually used which, by way of example, are laterally hinge-mounted on the doors or the respective A-pillar.

Since the exterior mirrors are usually arranged outside of the motor vehicle, these take up additional space in the width of the motor vehicle, thereby causing additional wind resistance, at high vehicle speeds, especially as the exterior mirrors act as wind capture surface areas at high speeds. Therefore, particularly at high vehicle speeds, an exterior mirror of a motor vehicle can lead to an increase in the drag coefficient (Cd) of 5% or more which in turn leads to increased gas consumption.

In normal motor vehicles, the function of the external mirrors is, for this reason in particular, increasingly assisted by cameras and associated display units, or the external mirrors of the motor vehicle are replaced completely by cameras and associated display devices.

From printed publication DE 10 2012 215 026 A1, a method is known for operating a motor vehicle having a first and a second camera, configured to detect a surrounding area of the motor vehicle. Here each of the cameras detects a single image of a first field of views and of a second field of view, wherein the fields of view overlap in an overlapping region. As a function of the image data of the individual images an object correction is also carried out and then, once the object correction has been performed, a complete image is established, which is put together as a function of the individual images.

Since cameras for detecting a surrounding region of a motor vehicle are usually arranged outside of the passenger compartment of the motor vehicle, however, they are necessarily exposed to environmental influences, which can lead to the cameras malfunctioning or becoming defective, by way of example, due to dirt or ice.

The object of the invention is to indicate a method and a system for representing vehicle surroundings of a motor vehicle on a display device located in the motor vehicle, with which the vehicle surroundings can be seen even in the event of a malfunction of a camera detecting the vehicle surroundings.

This object is achieved by the subject matter of the independent claims. Further advantageous developments are the subject matter of the dependent claims.

According to an embodiment of the invention, this object is achieved by a method for representing vehicle surroundings of a motor vehicle on a display device located in the motor vehicle, wherein the motor vehicle has at least one first camera for detecting a first surrounding region of the motor vehicle and one second camera for detecting a second surrounding region of the motor vehicle, and wherein the first surrounding region and the second surrounding region have an overlapping region. Here the method has the following steps: first receiving an activation signal to represent the first surrounding region on the display device and upon receiving the activation signal detecting whether there is a malfunction of the first camera. If no malfunction of the first camera is detected, the first surrounding region is represented on the display device. If a malfunction of the first camera is detected, at least part of the second surrounding region is represented as an alternative on the display device.

The basic concept is therefore, in the event of a malfunction of the first camera, instead of the data detected by the first camera, alternatively to represent the data detected by a second camera mounted on the motor vehicle, the field of view of which overlaps with the field of view of the first camera.

The advantage of such a method is that it allows the vehicle surroundings to be seen even if there is a malfunction of one of the cameras detecting the vehicle surroundings. Because cameras for detecting a surrounding region of a motor vehicle are normally arranged outside of the passenger compartment of the motor vehicle, the cameras can malfunction or become defective due to environmental influences to which these are necessarily exposed, by way of example due to dirt or ice. Since in this case data on a second surrounding region of the motor vehicle detected by a second camera, having an overlapping region with the first surrounding region, can be alternatively represented on the display device, in this case regions of the desired vehicle surroundings can also be represented on the display device and a driver of the motor vehicle can thus see these. This can increase the comfort of the driver of the motor vehicle further. Here, a malfunction of the first camera is understood to be a temporary dysfunction of the first camera, a temporary functional failure of the first camera or a defect of the first camera, such that the camera temporarily or permanently delivers no or only defective data. The step of detecting whether there is a malfunction of the first camera can take place as a one-off following receipt of the activation signal or also repeatedly over the length of time for which the first surrounding region is intended to be represented on the display device, by way of example at regular intervals of time.

Here the alternatively represented part of the second surrounding region can comprise the overlapping region. This particularly allows it to be ensured that even in the event of a malfunction of the first camera, the first surrounding region is at least partially represented on the display device.

According to one embodiment, the method can also have the following step: an indication is given to a driver of the motor vehicle that alternatively at least a part of the second surrounding region is being represented on the display device, if there is a malfunction of the first camera. The first surrounding region and the alternatively represented part of the second surrounding region are usually not identical, apart from the overlapping region. The indication allows the driver of the motor vehicle to be made aware that there is a malfunction of the first camera, and so the full first surrounding region is not represented on the display device, since the first surrounding region and the represented part of the second surrounding region are not identical, so that the latter is made aware that the part of the second surrounding region represented on the display device does not contain all information on the first surrounding region and is simply an aid. The driver is thus given an indication that he should take further action to obtain full information on the first surrounding region, by way of example looking over his shoulder.

The step of giving an indication to a driver of the motor vehicle, that alternatively at least a part of the second surrounding region is being represented on the display device, if there is a malfunction of the first camera, can comprise here coloring of the alternatively represented part of the second surrounding region. The advantage of this is that the driver can see the indication of the representation on the display device at the point where he would intuitively expect the representation of the first surrounding region to be. The indication may also involve other information signals suitable for making the driver aware that the entire first surrounding region is not being represented on the display device, by way of example a pop-up window appearing on the display device, a corresponding text output, or an acoustic or haptic signal.

Here the first camera can be arranged on a lateral exterior area of the motor vehicle and the first surrounding region can be a lateral rear area of the motor vehicle, and the second camera can be arranged on a rear end of the motor vehicle and the second surrounding region can be a rear area of the motor vehicle. Since in normal motor vehicles the function of the external mirrors is increasingly assisted by cameras and associated display units or the external mirrors of the motor vehicle are completely replaced by cameras and associated display devices, even in the event of a malfunction of these cameras, a driver of the motor vehicle can see the lateral rear area at least partially, in that alternatively data at least partially detected by a reversing camera are represented on the display device.

According to a further embodiment, the motor vehicle can further have a third camera for detecting a third surrounding region, wherein the first surrounding region and the third surrounding region have a second overlapping region and wherein the method further has the following steps: the second surrounding region and the third surrounding region are merged into a fused representation and the fused representation is represented on the display device if there is a malfunction of the first camera. Since the fused representation thus comprises parts of the second and the third surrounding region, the fused representation can thus contain more information on the first surrounding region and the driver of the motor vehicle can infer from the represented fused representation more information on the first surrounding region, compared with a situation in which alternatively only a part of the second or a part of the third surrounding region is represented on the display device, if there is a malfunction of the first camera. Here, merging the second and the third surrounding regions into a fused representation can, again, comprise performing an object correction.

Here the first camera can be arranged on the rear end of the motor vehicle and the first surrounding region can be the rear area of the motor vehicle, the second camera can be arranged on a left lateral exterior area of the motor vehicle and the second surrounding region can be a left lateral rear area of the motor vehicle, and the third camera can be arranged on a right lateral exterior area of the motor vehicle and the third surrounding region can be a right lateral rear area of the motor vehicle. So, if there is a malfunction of the reversing camera of the motor vehicle, in this case as well, the driver of the motor vehicle can infer information on the rear area of the motor vehicle from the fused representation represented on the display device of merged data from the cameras replacing the function of external mirrors on opposite sides of the vehicle.

In a further embodiment of the invention, a system for representing vehicle surroundings of a motor vehicle on a display device located in the motor vehicle is also indicated, wherein the motor vehicle has at least one first camera for detecting a first surrounding region of the motor vehicle and one second camera for detecting a second surrounding region of the motor vehicle, wherein the first surrounding region and the second surrounding region have an overlapping region. Here the system has a computer unit for converting the first surrounding region detected by the first camera into a first image data sequence and the second surrounding region detected by the second camera into a second image data sequence, a transmission unit for transmitting the first image data sequence and the second image data sequence for representation on the display device, a receiver unit for receiving an activation signal to represent the first surrounding region on the display device, and a detection unit for detecting if there is a malfunction of the first camera in response to the receipt of the activation signal. Here the transmission unit transmits the first image data sequence for representation on the display device, if there is no malfunction of the first camera. The transmission unit also transmits at least part of the second image data sequence for the alternative representation on the display device if there is a malfunction of the first camera.

Such a system has the advantage that the vehicle surroundings can be seen with it even if there is a malfunction of a camera detecting the vehicle surroundings. Because cameras for detecting a surrounding region of a motor vehicle are normally arranged outside of the passenger compartment of the motor vehicle, the cameras can malfunction or become defective due to environmental influences to which these are necessarily exposed, by way of example due to dirt or ice. Since in this case the transmission unit alternatively transmits at least a part of the second image data sequence, which is based on data detected by the second camera on a second surrounding region of the motor vehicle, which again has an overlapping region with the first surrounding region, for representation on the display device, in this case areas of the desired vehicle surroundings can also be represented on the display device and a driver of the motor vehicle can thus see these. This can further increase the comfort of a driver of the motor vehicle. Here a malfunction of the first camera is understood to be a temporary dysfunction of the first camera, a temporary functional failure of the first camera or a defect of the first camera, such that the camera temporarily or permanently delivers no or only defective data. Here the detection unit can be configured to detect whether there is a malfunction of the first camera as a one-off following receipt of the activation signal or also repeatedly over the length of time for which the first surrounding region is intended to be represented on the display device, by way of example at regular intervals of time.

Here the part of the second image data sequence transmitted by the transmission unit for alternative representation on the display device can comprise image data on the overlapping region. In this way, it can be ensured that even in the event of a malfunction of the first camera, the first surrounding region is represented at least partially on the display device.

According to one embodiment, the system can further have a signal generator for outputting an indication to a driver of the motor vehicle, that alternatively at least a part of the second image data sequence is being displayed on the display device, if there is a malfunction of the first camera. The first surrounding region and the alternatively represented part of the second surrounding region are normally not identical, apart from the overlapping region. As a result of the indication output by the signal generator the driver of the motor vehicle can be made aware that there is a malfunction of the first camera, and consequently that the full first surrounding region is not represented on the display device, since the first surrounding region and the represented part of the second surrounding region are not identical, so that the latter is made aware that the part of the second surrounding region represented on the display device does not contain all information on the first surrounding region and is simply an aid. The driver is thus given an indication that he should take further action to obtain full information on the first surrounding region, by way of example looking over his shoulder.

The indication can thereby comprise coloring of the alternatively represented part of the second surrounding region. The advantage of this is that the driver can see the indication of the representation on the display device at the point where he would intuitively expect the representation of the first surrounding region to be. The signal generator can also be configured, however, to generate further information signals suitable for making the driver aware that the entire first surrounding region is not being represented on the display device, by way of example a pop-up window appearing on the display device, a corresponding text output, or an acoustic or haptic signal.

Here the first camera can be arranged on a lateral exterior area of the motor vehicle and the first surrounding region can be a lateral rear area of the motor vehicle, and the second camera can be arranged on a rear end of the motor vehicle and the second surrounding region can be a rear area of the motor vehicle. Since in normal motor vehicles the function of the external mirrors is increasingly assisted by cameras and associated display units or the external mirrors of the motor vehicle are completely replaced by cameras and associated display devices, even in the event of a malfunction of these cameras, a driver of the motor vehicle can see the lateral rear area at least partially, in that alternatively data at least partially detected by a reversing camera are represented on the display device.

According to one embodiment, the motor vehicle can further have a third camera for detecting a third surrounding region of the motor vehicle, wherein the first surrounding region and the third surrounding region have a second overlapping region and wherein the computer unit converts the third surrounding region detected by the third camera into a third image data sequence. Here the system can further have a computer unit for merging the second image data sequence and the third image data sequence into a fused representation, wherein the transmission unit transmits the fused representation generated by the processing unit for representation on the display device, if there is a malfunction of the first camera. Since the fused representation thus comprises parts of the second and the third surrounding region, the fused representation can thus contain more information on the first surrounding region and the driver of the motor vehicle can infer from the fused representation represented on the display device more information on the first surrounding region, compared with a situation in which alternatively only part of the second or a part of the third surrounding region are represented on the display device, if there is a malfunction of the first camera. Here, merging the second and the third surrounding region by the computer unit into a fused representation can, again, comprise performing an object correction.

Here the first camera can be arranged on the rear end of the motor vehicle and the first surrounding region can be the rear area of the motor vehicle, the second camera can be arranged on a left lateral exterior area of the motor vehicle and the second surrounding region can be a left lateral rear area of the motor vehicle, and the third camera can be arranged on a right lateral exterior area of the motor vehicle and the third surrounding region can be a right lateral rear area of the motor vehicle. So, if there is a malfunction of the reversing camera of the motor vehicle, in this case as well, the driver of the motor vehicle can infer information on the rear area of the motor vehicle from the fused representation represented on the display device of merged data from the cameras replacing the function of external mirrors on opposite sides of the vehicle.

A further embodiment of the invention also indicates a motor vehicle, having a system as described above.

Such a motor vehicle has the advantage that a driver of the motor vehicle via the display device arranged in the motor vehicle can see, via the display device arranged in the motor vehicle, the vehicle surroundings even if there is a malfunction of one of the cameras detecting the vehicle surroundings. Since cameras for detecting a surrounding region of a motor vehicle are usually arranged outside of the passenger compartment of the motor vehicle, they are necessarily exposed to environmental influences, which can lead to the cameras malfunctioning or becoming defective, by way of example, due to dirt or ice. Since in this case alternatively at least part of the second image data sequence, which is based on data detected by the second camera on a second surrounding region of the motor vehicle, which again has an overlapping region with the first surrounding region, is transmitted for representation on the display device, in this case also regions of the desired vehicle surroundings can be represented on the display device and a driver of the motor vehicle can thus see these. This can increase the comfort of the driver of the motor vehicle further. Here, a malfunction of the first camera is understood to be a temporary dysfunction of the first camera, a temporary functional failure of the first camera or a defect of the first camera, such that the camera temporarily or permanently delivers no or only defective data.

In conclusion, the invention indicates a method and a system for representing vehicle surroundings of a motor vehicle on a display device located in the motor vehicle, with which the vehicle surroundings can be seen even if there is a malfunction of one of the cameras detecting the vehicle surroundings.

In this way, if there is a malfunction of a first camera detecting a first surrounding region of the motor vehicle, data on a second surrounding region of the motor vehicle detected by a second camera, having an overlapping region with the first surrounding region, can alternatively be represented on the display device and thus in this case regions of the desired vehicle surroundings are also represented on the display device, a driver is able to see these.

By outputting a corresponding indication, the driver of the motor vehicle can be made aware here that there is a malfunction of the first camera, and so the full first surrounding region is not represented on the display device, since the first surrounding region and the represented part of the second surrounding region are not identical, so that the part of the second surrounding region represented on the display device does not contain all information on the first surrounding region.

The invention is explained in more detail using the attached figures.

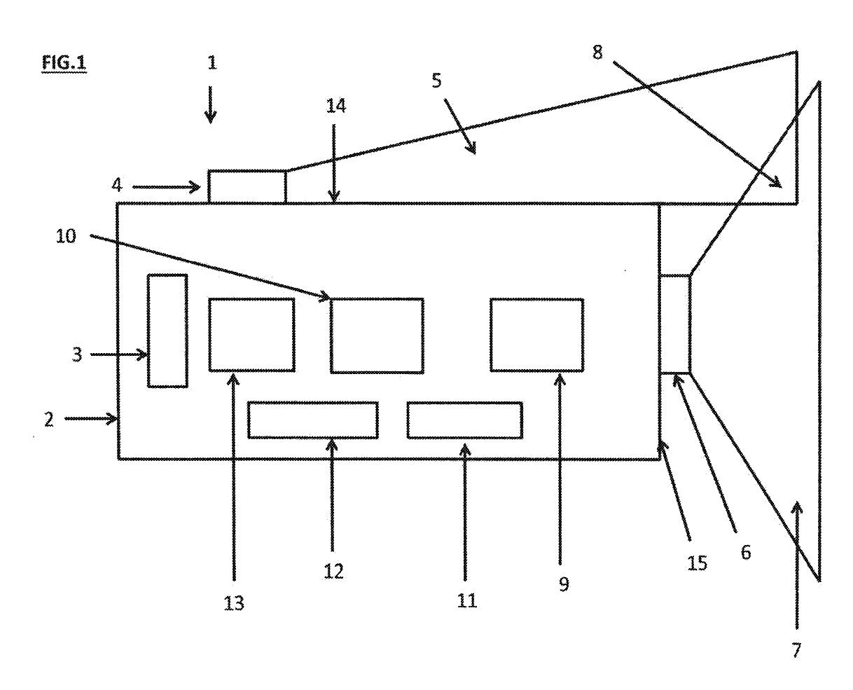

FIG. 1 is a schematic view of a system for representing vehicle surroundings of a motor vehicle on a display device arranged in the motor vehicle according to a first embodiment of the invention;

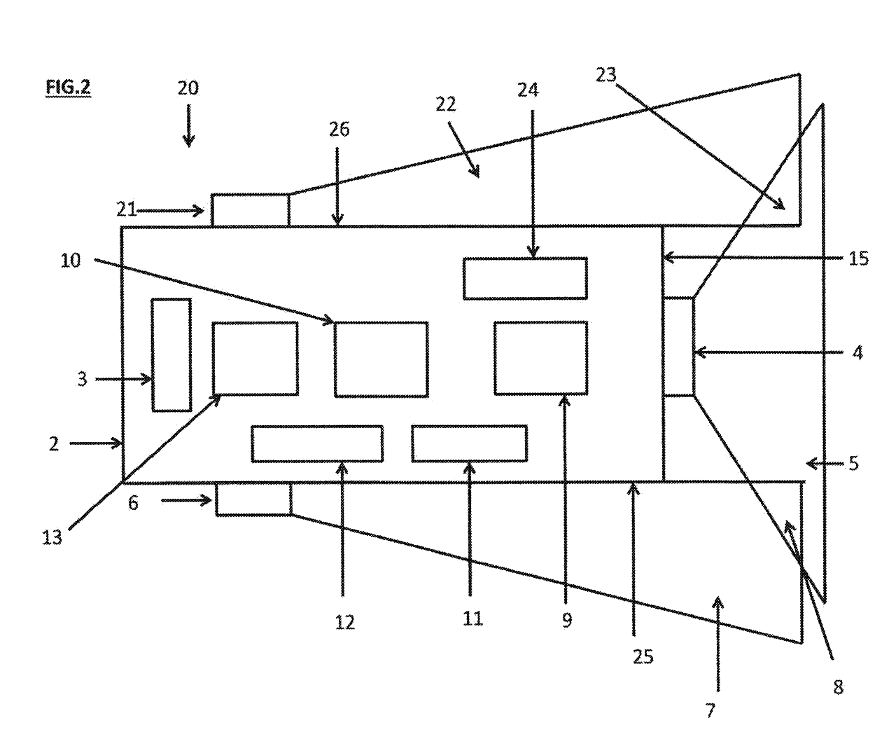

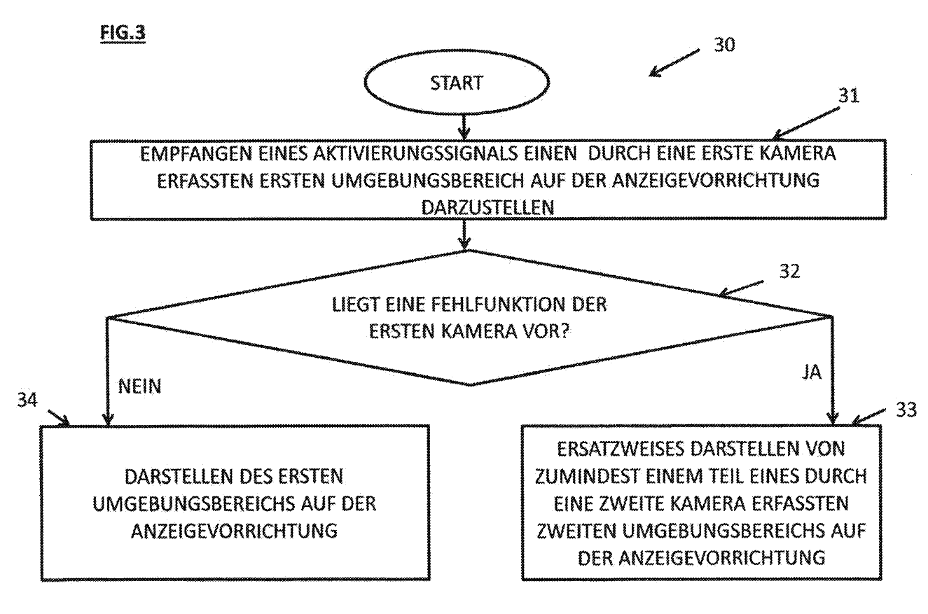

FIG. 2 is a schematic view of a system for representing vehicle surroundings of a motor vehicle on a display device arranged in the motor vehicle according to a second embodiment of the invention;

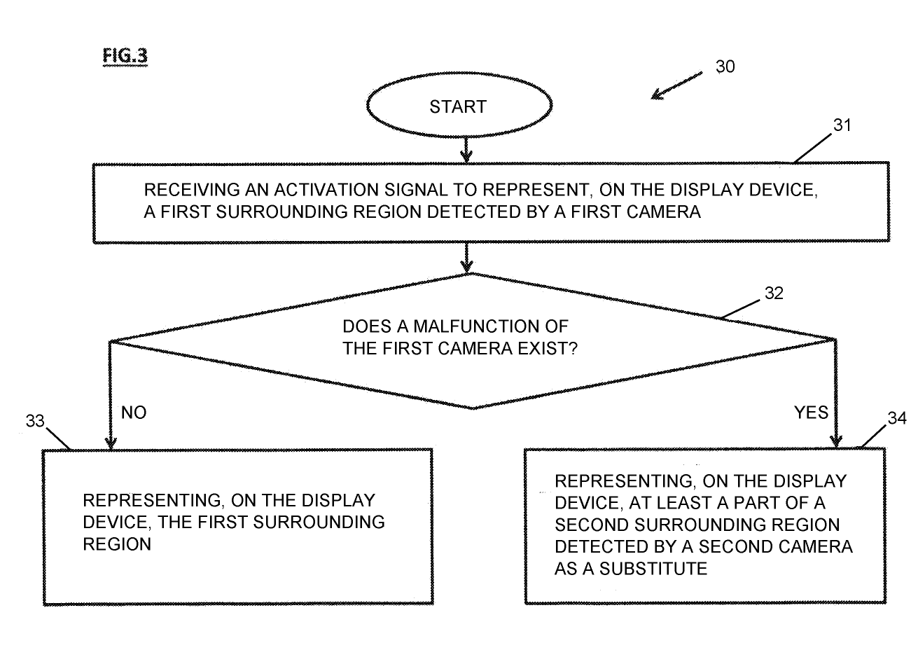

FIG. 3 is a flow chart of a method for representing vehicle surroundings of a motor vehicle on a display device arranged in the motor vehicle according to embodiments of the invention.

FIG. 1 is a schematic view of a system 1 for representing vehicle surroundings of a motor vehicle 2 on a display device 3 arranged in the motor vehicle 2 according to a first embodiment of the invention.

As shown in FIG. 1, the motor vehicle 2 has one first camera 4 for detecting a first surrounding region 5 of the motor vehicle 2 and one second camera 6 for detecting a second surrounding region 7 of the motor vehicle 2, wherein the first surrounding region 5 and the second surrounding region 7 have an overlapping region 8.

A computer unit 9 for converting the first surrounding region 5 detected by the first camera 4 into a first image data sequence and the second surrounding region 7 detected by the second camera 6 into a second image data sequence, and a transmission unit 10 for transmitting the first image data sequence and the second image data sequence for representation on the display device 3, can also be identified.

Since cameras for detecting a surrounding region of a motor vehicle are usually arranged outside of the passenger compartment of the motor vehicle, however, they are necessarily exposed to environmental influences, which can lead to the cameras malfunctioning or becoming defective, by way of example, due to dirt or ice.

As shown in FIG. 1, here the represented system 1 also has a receiver unit 11 for receiving an activation signal for representing the first surrounding region on the display device 3 and a detection unit 12 for detecting if there is a malfunction of the first camera 4 in response to the receipt of the activation signal. The transmission unit 10 is also configured to transmit the first image data sequence for representation on the display device 3, if there is no malfunction of the first camera 4, and to transmit at least part of the second image data sequence to the display unit 3 for alternative representation, if there is a malfunction of the first camera 4.

Since, in the event of a malfunction of the first camera 4, the transmission unit 10 alternatively transmits at least part of the second image data sequence, which is based on data detected by the second camera 6 on a second surrounding region 7 of the motor vehicle 2, which again has an overlapping region 8 with the first surrounding region 5, for representation on the display device 3, in this case areas of the desired vehicle surroundings can also be represented on the display device 3 and a driver of the motor vehicle 2 can thus see these. Here a malfunction of the first camera 4 is understood to be a temporary dysfunction of first camera 4, a temporary functional failure of the first camera 4 or a defect of the first camera 4, such that the camera temporarily or permanently delivers no or only defective data. Here the detection unit 12 can be configured to detect whether there is a malfunction of the first camera 4 as a one-off following receipt of the activation signal or also repeatedly over the length of time for which the first surrounding region 5 is intended to be represented on the display device 3, by way of example at regular intervals of time.

According to the embodiment of FIG. 1, here the part of the second image data sequence 8 transmitted by the transmission unit 10 for alternative representation on the display device 3 can comprise image data on the overlapping region 8. In this way, it can be ensured that even in the event of a malfunction of the first camera 4, the first surrounding region 5 is represented at least partially on the display device 3.

A signal generator 13 can also be identified, configured for outputting an indication to a driver of the motor vehicle 2, that alternatively at least a part of the second image data sequence is being represented on the display device 3, if there is a malfunction of the first camera 4. Here, by outputting the indication the driver of the motor vehicle 2 can be made aware that there is a malfunction of the first camera 4, and so the full first surrounding region 5 is not represented on the display device 3, since the first surrounding region 5 and the represented part of the second surrounding region 7 are not identical, so that the latter is made aware that the part of the second surrounding region 7 represented on the display device 3 does not contain all information on the first surrounding region 5.

According to the embodiment of FIG. 1, the indication thereby comprises coloring of the alternatively represented part of the second surrounding region. The signal generator can also be configured, however, to generate further information signals suitable for making the driver aware that the entire first surrounding region is not being represented on the display device, by way of example a pop-up window appearing on the display device, a corresponding text output, or an acoustic or haptic signal.

Here the first camera 4 is arranged on a lateral exterior area 14 of the motor vehicle 2 and the first surrounding region 5 is a lateral rear area of the motor vehicle 2, and the second camera 6 is arranged on a rear end 15 of the motor vehicle 2 and the second surrounding region 7 is a rear area of the motor vehicle 2. Since in normal motor vehicles the function of the external mirrors is increasingly assisted by cameras and associated display units or the external mirrors of the motor vehicle are completely replaced by cameras and associated display devices, even in the event of a malfunction of these cameras, a driver of the motor vehicle can see the lateral rear area at least partially, in that alternatively at least partially data detected by a reversing camera are represented on the display device 3. Here the display device 3 can, by way of example, be a display device of such an external mirror alternative system of the motor vehicle 2.

FIG. 2 is a schematic representation of a system 20 for representing vehicle surroundings of a motor vehicle 2 on a display device 3 arranged in the motor vehicle 2 according to a second embodiment of the invention. Components and parts with the same function or design as in FIG. 1 are given the same reference numerals and no further explanation is given.

According to the embodiment of FIG. 2, the motor vehicle 2 also has a third camera 21 for detecting a third surrounding region 22 of the motor vehicle 2, wherein the first surrounding region 5 and the third surrounding region 22 have a second overlapping region 23 and wherein the computer unit 9 converts the third surrounding region 22 detected by the third camera 21 into a third image data sequence.

As can be seen from FIG. 2, here the system 20 also has a processing unit 24 for merging the second image data sequence and the third image data sequence into a fused representation, wherein the transmission unit 10 transmits the fused representation for representation on the display device 3 if there is a malfunction of the first camera 4. Here, the merging of the second 7 and the third surrounding region 22 by the processing unit 24 into a fused representation, again, includes performing an object correction.

Here the first camera 4 can be arranged on the rear end 15 of the motor vehicle 2 and the first surrounding region 5 can be the rear area of the motor vehicle 2, the second camera 6 can be arranged on a left lateral exterior area 25 of the motor vehicle 2 and the second surrounding region 7 can be a left lateral rear area of the motor vehicle, and the third camera 21 can be arranged on a right lateral exterior area 26 of the motor vehicle 2 and the third surrounding region 22 can be a right lateral rear area of the motor vehicle 2. In this way, if there is a malfunction of the reversing camera of the motor vehicle 2, in this case as well, the driver of the motor vehicle 2 can infer information on the rear area of the motor vehicle 2 from the fused representation represented on the display device 3 of merged data from the cameras replacing the function of external mirrors on opposite sides of the vehicle 2. Here the display device 3 can, by way of example, be a display device of an interior mirror system of the motor vehicle 2.

FIG. 3 is a flow chart of a method 30 for representing vehicle surroundings of a motor vehicle on a display device located in the motor vehicle according to embodiments of the invention.

FIG. 3 specifically shows a method 30 for representing vehicle surroundings of a motor vehicle on a display device located in the motor vehicle, wherein the motor vehicle has at least one first camera for detecting a first surrounding region of the motor vehicle and one second camera for detecting a second surrounding region of the motor vehicle, and wherein the first surrounding region and the second surrounding region have an overlapping region.

As shown in FIG. 3, here the method 30 has the following steps: in a first step 31 an activation signal for representing the first surrounding region on the display device is first received and, following receipt of the activation signal, in step 32 it is detected if there is a malfunction of the first camera. If it is detected in step 32 that there is no malfunction of the first camera, in step 33 the first surrounding region is represented on the display device. If it is detected in step 33 that there is a malfunction of the first camera, in step 34 alternatively at least a part of the second surrounding region is represented on the display device. Here a malfunction of the first camera is understood to be a temporary dysfunction of the first camera, a temporary functional failure of the first camera or a defect of the first camera, such that the camera temporarily or permanently delivers no or only defective data.

### LIST OF REFERENCE NUMERALS

1 System
2 Motor vehicle
3 Display device
4 First camera
5 First surrounding region
6 Second camera
7 Second surrounding region
8 Overlapping region
9 Computer unit
10 Transmission unit
11 Receiver unit
12 Detection unit
13 Signal generator
14 Lateral exterior area
15 Rear end
20 System
21 Third camera
22 Third surrounding region
23 Second overlapping region
24 Processing unit
25 Left lateral exterior area
26 Right lateral exterior area
30 Method
31 Method step
32 Method step
33 Method step
34 Method step

1. A method for representing vehicle surroundings of a motor vehicle on a display device located in the motor vehicle, wherein the motor vehicle has at least one first camera for detecting a first surrounding region of the motor vehicle and one second camera for detecting a second surrounding region of the motor vehicle, wherein the first surrounding region and the second surrounding region have B an overlapping region and wherein the method (30) has the following steps:
receiving an activation signal to represent the first surrounding region on the display device (31);
upon receiving the activation signal, detecting whether there is a malfunction of the first camera (32);
representing the first surrounding region on the display device, if there is no malfunction of the first camera (33), and representing at least part of the second surrounding region on the display device as an alternative if there is a malfunction of the first camera (34).

2. The method according to claim 1, wherein the alternatively represented part of the second surrounding region comprises the overlapping region.

3. The method according to claim 1, wherein the method (30) further has the following step:
outputting an indication to a driver of the motor vehicle, that alternatively at least a part of the second surrounding region is being represented on the display device, if there is a is a malfunction of the first camera.

4. The method according to claim 3, wherein the step of outputting an indication for a driver of the motor vehicle, that alternatively at least a part of the second surrounding region is being represented on the display device, if there is a malfunction of the first camera, comprises a coloring of the alternatively represented part of the second surrounding region.

5. The method according to claim 1, wherein the first camera is arranged on a lateral exterior area of the motor vehicle and the first surrounding region is a lateral rear area of the motor vehicle, and the second camera is arranged on a rear end of the motor vehicle and the second surrounding region is a rear area of the motor vehicle.

6. The method according to claim 1, wherein the motor vehicle also has a third camera for detecting a third surrounding region, wherein the first surrounding region and the third surrounding region have a second overlapping region, and wherein the method (30) also has the following steps:
merging of the second surrounding region and the third surrounding region into a fused representation;
representing the fused representation on the display device, if there is a malfunction of the first camera.

7. The method according to claim 6, wherein the first camera is arranged on the rear end of the motor vehicle and the first surrounding region is the rear area of the motor vehicle, the second camera is arranged on a left lateral exterior area of the motor vehicle and the second surrounding region is a left lateral rear area of the motor vehicle, and the third camera is arranged on a right lateral exterior area of the motor vehicle and the third surrounding region is a right lateral rear area of the motor vehicle.

8. A system for representing vehicle surroundings of a motor vehicle on a display device (3) arranged in the motor vehicle (2), wherein the motor vehicle (2) has at least one first camera (4) for detecting a first surrounding region (5) of the motor vehicle (2) and one second camera (6) for detecting a second surrounding region (7) of the motor vehicle (2), wherein the first surrounding region (5) and the second surrounding region (7) have an overlapping region (8) and wherein the system (1,20) has a computer unit (9) for converting the first surrounding region (5) detected by the first camera (4) into a first image data sequence and the second surrounding region (7) detected by the second camera (6) into a second image data sequence, a transmission unit (10) for transmitting the first image data sequence and the second image data sequence for representation on the display device (3), a receiver unit (11) for receiving an activation signal to represent the first surrounding region (5) on the display device (3), and a detection unit (12) for detecting if there is a malfunction of the first camera (4) in response to the receipt of the activation signal, and wherein the transmission unit (10) transmits the first image data sequence for representation to the display device (3), if there is no malfunction of the first camera (4), and transmits at least part of the second image data sequence for representation as an alternative on the display device (3), if there is a malfunction of the first camera (4).

9. The system according to claim 8, comprising image data on the overlapping region (8), through the part of the second image data sequence transmitted by the transmission unit (10) to the display device (3) for alternative representation.

10. The system according to claim 8, wherein the system (1, 20) also has a signal generator (13) for outputting an indication for a driver of the motor vehicle (2), that alternatively at least a part of the second image data sequence will be represented on the display device (3), if there is a malfunction of the first camera (4).

11. The system according to claim 10, wherein the indication comprises a coloring of the alternatively represented part of the second image data sequence.

12. The system according to claim 8, wherein the first camera (4) is arranged on a lateral exterior area (14) of the motor vehicle (2) and the first surrounding region (5) is a lateral rear area of the motor vehicle (2), and the second camera (6) is arranged on a rear end (15) of the motor vehicle (2) and the second surrounding region (7) is a rear area of the B motor vehicle (2).

13. The system according to claim 8, wherein the motor vehicle (2) also has a third camera (21) for detecting a third surrounding region (22) of the motor vehicle (2), wherein the first surrounding region (5) and the third surrounding region (22) have a second overlapping region (23), wherein the computer unit (9) converts the third surrounding region (22) detected by the third camera (21) into a third image data sequence and the system (20) also has a processing unit (24) for merging the second image data sequence and the third image data sequence into a fused representation and wherein the transmission unit (10) transmits the fused representation for representation to the display device (3), if there is a malfunction of the first camera (4).

14. The system according to claim 13, wherein the first camera (4) is arranged on the rear end (15) of the motor vehicle (2) and the first surrounding region (5) is a rear area of the motor vehicle (2), the second camera (6) is arranged on a left lateral exterior area (25) of the motor vehicle (2) and the second surrounding region (7) is a left lateral rear area of the motor vehicle (2), and the third camera (21) is arranged on a right lateral exterior area (26) of the motor vehicle (2) and the third surrounding region (22) is a right lateral rear area of the motor vehicle (2).

15. A combination comprising a system (1, 20) according to claim 8 provided on a motor vehicle.
